(19) United States
(12) Patent Application Publication
(10) Pub. No.: US 2006/0229799 A1
(43) Pub. Date: Oct. 12, 2006

(54) Fleet data reporting and benchmarking system and method

(75) Inventors: Thomas Nimmo, Plymouth, MN (US); Christopher Shaffer, St. Paul, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(73) Assignee: Utilimarc, Inc., St. Paul, MN (US)

(21) Appl. No.: 11/094,861

(22) Filed: Mar. 31, 2005

(51) Int. Cl. G08G 1/00

(52) U.S. Cl. 701/117

(57) ABSTRACT

A system and method for standardizing fleet data and for enabling users of the system and method to selectively retrieve and report one participating fleet's standardized fleet data values in comparative relation to that of other participating fleets.

### BACKGROUND OF THE INVENTION

1. Field of the Invention

The present invention relates generally to fleet reporting and benchmarking systems and methods, and, more particularly, to a system and method for standardizing fleet data values and for enabling one fleet to selectively retrieve and report its standardized fleet data values in comparative relation to that of other participating fleets.

2. Description of the Related Art

The more information, insight and knowledge one has regarding the likely outcome or effect of one's business decisions, the more confidence one will have making those decisions. Accordingly, as with most other types of businesses, most fleet operations monitor and track their costs, revenues, efficiencies, and other factors effecting the profitability of the business in order to build a historical record upon which to rely when making business decisions effecting the company's future. While purely intra-company historical data comparisons or benchmarking reports may provide some reference upon which management can rely when making business decisions, such pure intra-company data does not afford management any insight as to the company's costs, profitability or efficiencies in comparison to its competitors or other similarly situated companies.

Of course, no business will disclose its confidential and proprietary business information to competitors, particularly where its confidential and proprietary business practices have enabled it to obtain a commercial advantage over its competitors. However, if companies could share their confidential and proprietary business information without destroying the trade secret status of such information, for example by sharing that information in a non-identifiable manner, then such companies could still achieve the benefits of knowing where they are positioned with respect to their competitors by benchmarking their fleet data against the aggregate fleet data of their competitors. Armed with such data, companies will be able to make better business decisions effecting their position in the marketplace, their efficiencies, costs, revenues and, ultimately, their profitability.

For example, it is submitted that an electric utility company, for example, would find it advantageous to know how its purchase costs of medium duty bucket trucks, for example, compares to that of other electric utility companies within a particular state, region or throughout the entire country. If that electric utility company could compare its historical purchase costs in a comparative relation against purchase costs of other similarly situated utilities, it will be able to use that benchmark information to know whether it is paying more for its vehicles than its competitors. If its purchase costs are greater than other utilities, the utility company can use that information to shop for better prices from its existing suppliers or it can look to a new supplier who can offer a better price.

As another example, a telecommunications company would likely find it advantageous to be able to view its total annual fleet costs benchmarked against the total annual fleet costs of its competitors. Even more advantageous would be the ability for that telecommunications company to benchmark its ownership costs, operating costs and overhead against that of its competitors on a per unit basis at the lowest levels, such as by category, type or class of vehicle. For example, if a company could compare its fleet mix to that of its competitors (e.g., the ratio of units comprising the fleet, such as the ratio of vehicles to trailers to power operated equipment (POE)), and if it could obtain a comparison by unit category (e.g., by vehicle, by trailer, or by POE), and even a more detailed comparison, such as by vehicle type (e.g., vans, pickups, bucket-trucks, etc.), and even a more detailed comparison at a still lower level, such as by vehicle class (e.g., light duty pickups), then the company could more easily identify its strengths and weaknesses with respect to its competitors. With this information, the company can adopt new business strategies or modify its existing business strategies to improve in those areas where it is lagging its competitors.

Unfortunately, however, unless all companies are consistently tracking the same type of business data, using the same methodology, and the same accounting practices, it is not possible to obtain an accurate comparison between various company operations. To compound the problem, even among the various vehicle fleet management software programs currently available on the market which purport to track vehicle fleet data, these various programs are not consistent in their accounting and data reporting functions. Due to this lack of standardization, even if the exact same input is entered into the various commercially available fleet management programs, the reported data output values may vary.

For example, if an electric utility company desires to know how its operating costs for its medium duty service trucks, the results may vary depending on the fleet management program used. Thus, unless every other company to which the utility company desires to benchmark its data against uses the uses the same vehicle fleet management program, the benchmarking report will not be a true “apples-to-apples” comparison.

Thus, while each of the various commercially available fleet management programs may serve their intended purpose, there is a need within the vehicle fleet management industry for standardizing vehicle fleet data to enable accurate benchmarking comparisons.

Overcoming the lack of standardization in the various fleet management programs, however, provides only half of the solution for allowing one fleet operation to benchmark its fleet data against the fleet data of other fleet operations. In other words, even if all of the commercially available fleet management programs each used the same terminology, calculations and output formats, fleet operators would still not be able to benchmark their data values against those of other fleet operations for comparison purposes without an efficient means of uploading or otherwise sharing their data on a non-personally identifiable basis, and from which the fleet operators can then select various attributes for benchmarking their operation against those of other fleet operations having similar attributes.

Thus, there is also a need in the vehicle fleet industry to allow uploading or sharing of an operation's fleet data on a non-identifiable basis for access and querying by other fleet operators for generating benchmarking reports based upon select criteria. There is also a need in the vehicle fleet industry to enable the generation of benchmarking reports for comparison of the data values of one or more fleet operations to the data values of other fleet operations based upon select attributes. With access to such reports for comparison purposes, fleet operators will be armed with the information needed to improve the profitability of their respective fleet operations.

### SUMMARY OF THE INVENTION

A system and method for standardizing fleet data and for enabling users of the system and method to selectively retrieve and report one participating fleet's standardized fleet data values in comparative relation to that of other participating fleets. The selective retrieval of the standardize fleet data values of the participating fleets is preferably performed by executing queries through a user interface, the queries defined by one or more attributes associated with the participating fleets.

In one embodiment of the system and method of the present invention, a application service provider architecture may be utilized. In another embodiment of the system and method of the present invention, a Napster-type architecture may be utilized. In another embodiment of the system and method of the present invention a Gnutella type architecture may be utilized.

### BRIEF DESCRIPTION OF THE DRAWINGS

FIG. 1 is a flowchart illustrating a portion of the system and method of the present invention.

FIG. 2 illustrates an application service provider (ASP) architecture which may be utilized for the system and method of the present invention.

FIG. 3 illustrates a Napster-type architecture which may be utilized for the system and method of the present invention.

FIG. 4 illustrates a Gnutella-type architecture which may be utilized for the system and method of the present invention.

FIG. 5 illustrates an embodiment of a registration page which may be used with the system and method of the present invention.

FIGS. 6A-6B illustrates an embodiment of a fleet attribute form which may be used with the system and method of the present invention.

FIG. 7 is an example of a fleet classification scheme which may be used with the system and method of the present invention.

FIG. 8 is an example of a fleet data file which may be used with the system and method of the present invention.

FIGS. 10-24 are examples of various report formats which may be generated using the system and method of the present invention.

FIG. 25 is an example of a user interface tool for associating authorized users with a fleet.

### DETAILED DESCRIPTION OF THE INVENTION

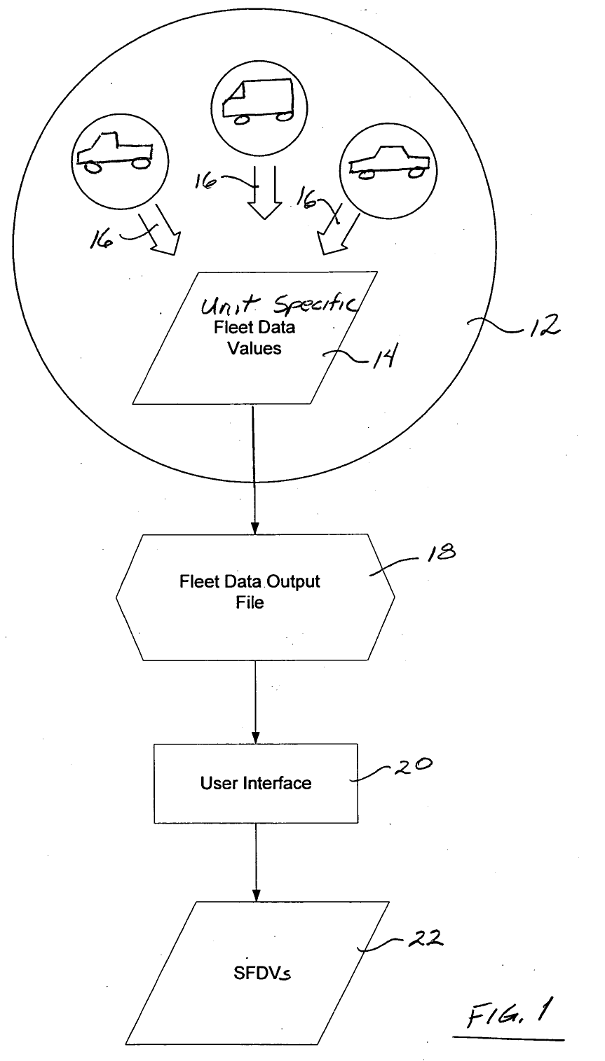

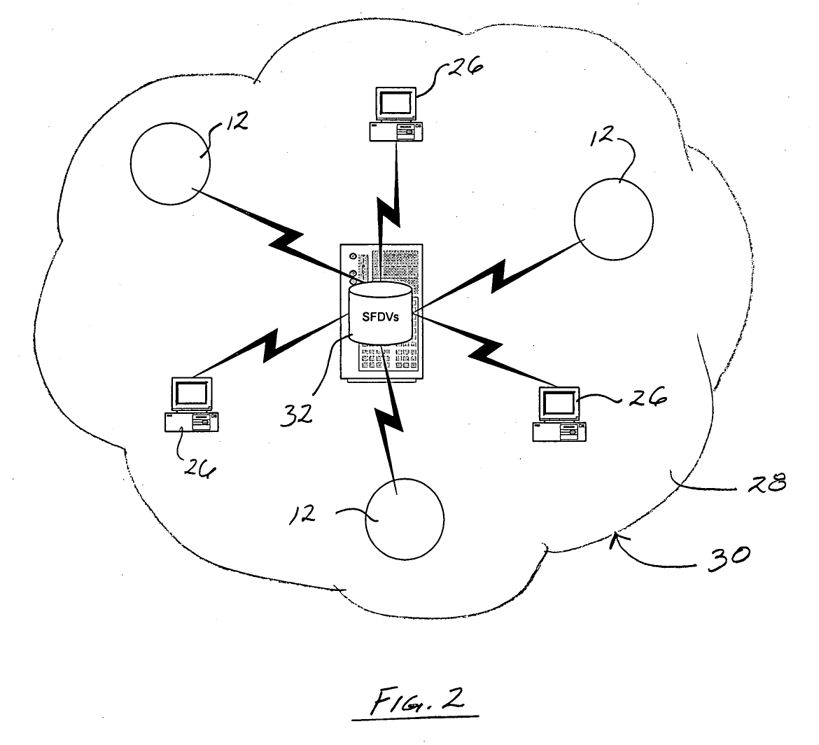

Referring to the drawings wherein like reference numerals designate identical or corresponding parts or features throughout the several drawing figures, FIG. 1 illustrates graphically one embodiment of the vehicle fleet data reporting and benchmarking system and method of the present invention, hereinafter the “fleet system” designated generally by reference numeral 10.

As illustrated in FIG. 1, a participating fleet 12 utilizes a fleet management program 14 to collect fleet data values 16. The fleet management program 14 is preferably capable of outputting a formatted data file 18 comprising the unit specific fleet data values 16 formatted and arranged in a predefined electronic output format. Through a user interface 20, the unit specific fleet data values 16 are preferably “standardized” into Standardized unit specific Fleet Data Values (SFDVs) 22. These SFDVs 22 are also preferably associated with attributes 24 identifying the characteristics and features of the fleet 12 by which participating fleets 12 and other users 26 of the system 10 can query for benchmarking one fleets SFDVs 22 in a comparative relation to SFDVs 22 of other participating fleets 12.

Depending on the type of architecture being utilized by the system 10, (i.e., an application service provider (ASP) model or a peer-to-peer (P2P) model (discussed later)) the SFDVs 22 and associated fleet attributes 24 may be stored on a central server or on the participating fleet's 12 computer system. In any event, through the user interface 20, the fleet participants 12 and other users 26 of the system 10 are able to query the attributes 24 of participating fleets 12 to selectively retrieve the SFDVs 22 of one or more participating fleets 12 having the queried fleet attributes 24. The system 10 further permits the selectively retrieved SFDVs 22 to be displayed in various report formats, including in a comparative relation with the SFDVs 22 of other participating fleets 12.

As used herein, the term “user” refers to any individual or organization that accesses and uses the fleet system 10. The term “fleet participant” should be understood as referring to a fleet operation that participates in the sharing of its SFDVs 22 and other fleet attributes 24 for querying, viewing and benchmarking by other users 26 and participants 12. As will become apparent later a user 26 may not be a participant 12, but a participant 12 is necessarily within the above definition of a user 26. Accordingly, for simplicity, the term user 26 should hereinafter be understood as including a participant unless otherwise indicated.

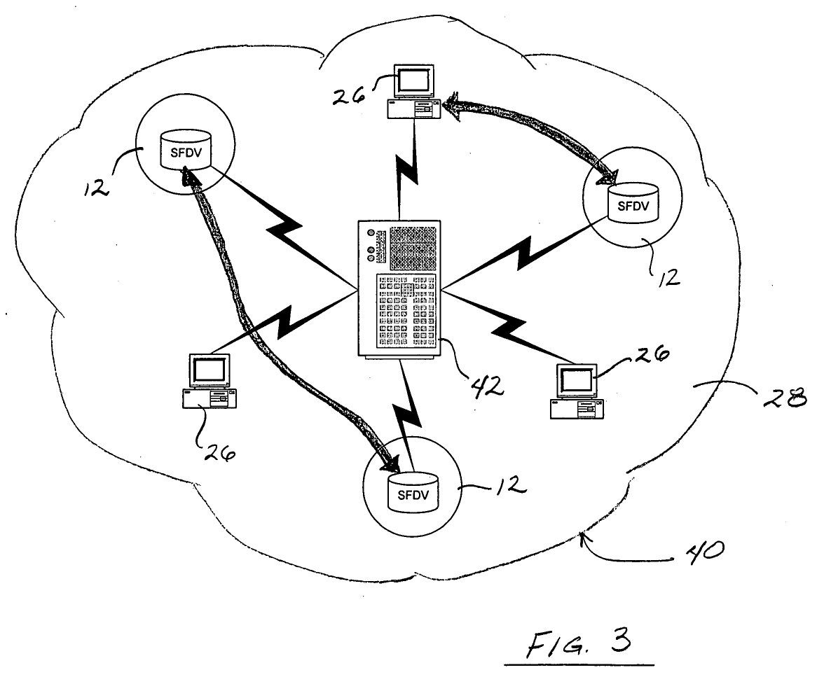

As illustrated in FIG. 2, the system 10 may utilize an ASP type architecture designated generally by reference numeral 30. Under an ASP architecture, the system 10 comprises a central database server 32 which stores the SFDVs 22 and associated attributes 24 of the participating fleets 12. The central database server 32 is preferably accessible simultaneously by multiple users 26 of the fleet system 10 via a system of linked computer, computer servers or linked computer networks (collectively and/or individually “computers”) connected by means of a common communications protocol. This series of linked computers or linked computer networks connect by means of a common communications protocol is hereinafter referred to as the “internet” and is designated generally by reference numeral 28.

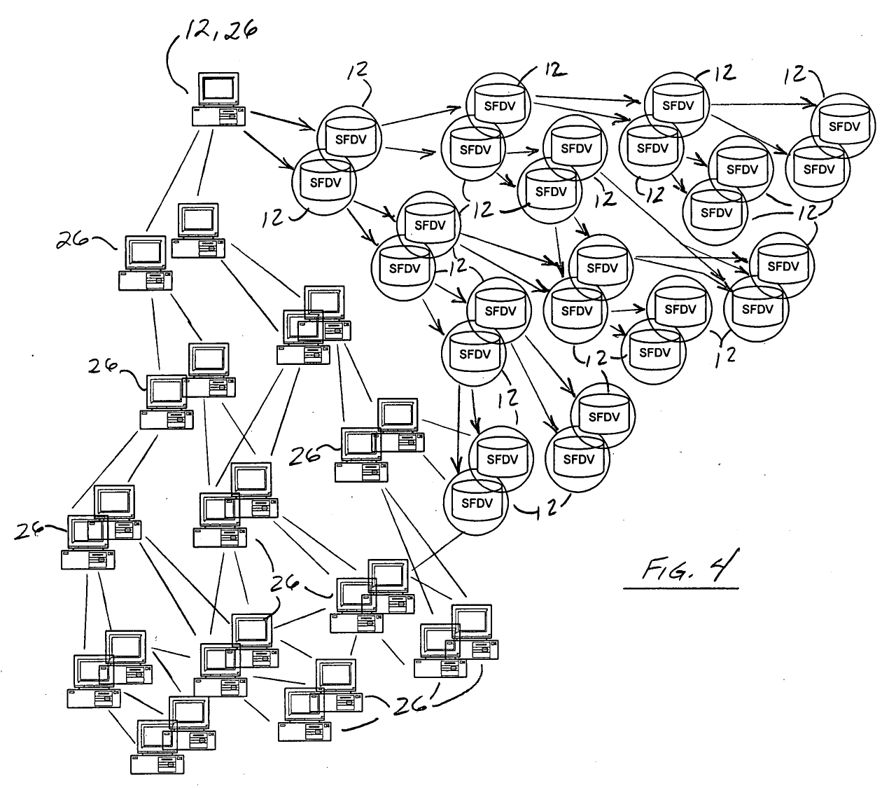

In an alternative embodiment, as illustrated in FIG. 3, rather than utilizing an ASP architecture 30 wherein the SFDVs 22 are stored on a central database server 32 accessible only through the ASP's system, the fleet system 10 may instead utilize a Napster® type peer-to-peer (P2P) file sharing architecture 40 in which a central index server 42 maintains a listing of all fleet participants 12 and certain associated fleet attributes 24. Using this Napster type architecture 40, users 26 can query the central index server 42 to identify participants 12 having the attributes 24 meeting the user's benchmark query criteria. Once a participant from the central index server 42 is identified, the user 26 is preferably provided with a hyperlink 44 to directly connect to the participant's computer system for selectively retrieving the desired SFDVs 22 of the participating fleet 12 for use in generating the benchmarking reports or other reports in comparative relation to the SFDVs 22 of other participating fleets 12. For a better understanding and a more detailed description of the operation, features and functionalities of the Napster type architecture system 40, see http://computer.howstuffworks.com/napster.htm/printable, the entire contents of which forms a part of this patent application is incorporated herein by reference.

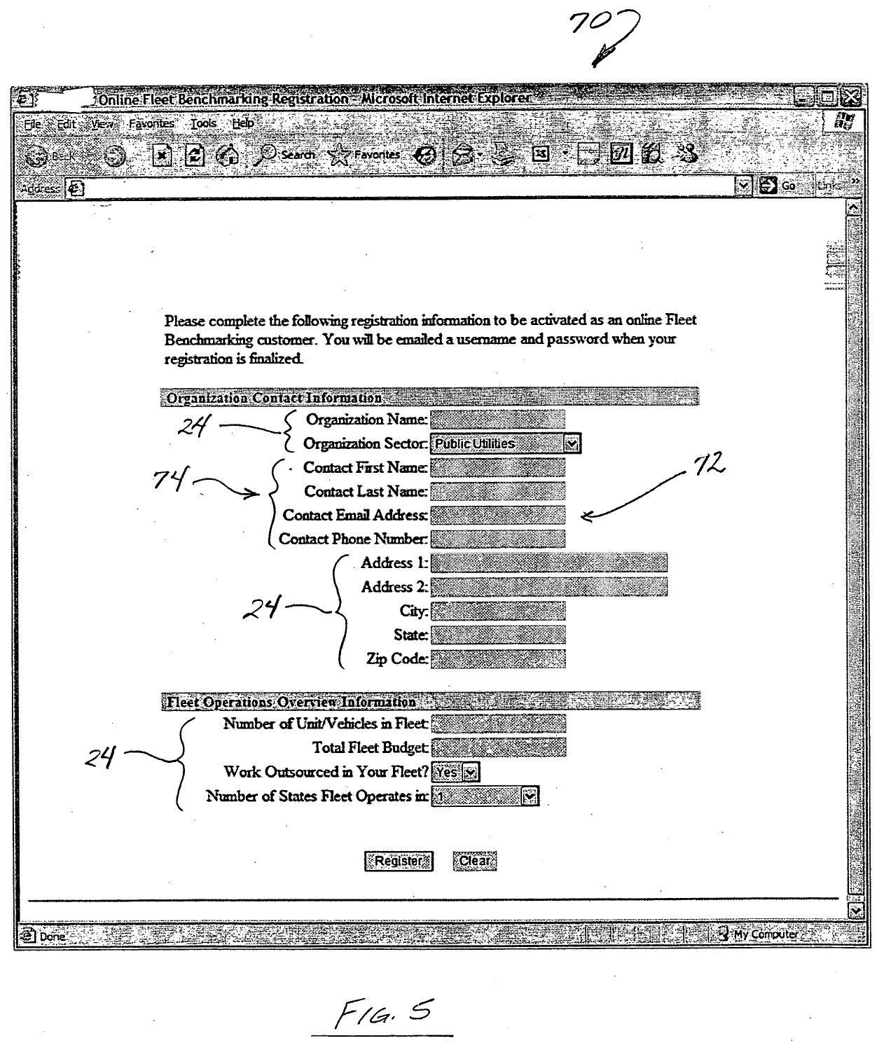

In still another alternative embodiment, as illustrated in FIG. 4, the fleet system 10 may utilize a Gnutella™ type P2P file sharing architecture 50 which relies on a distributed query approach to sharing files. Under a Gnutella type architecture system 50, there is no central database server 32 or a central index server 42. Instead, participants 12 communicate and share directly for querying and selective retrieval their respective fleet attributes 24 and SFDVs 22. For example, if a user 26 executes a benchmarking query to identify the purchase costs of medium duty bucket trucks by all electric utilities located in the southeastern United States, the Gnutella type system 50 will connect to the participant's host computer servers 52 (e.g., by IP address) preprogrammed or pre-designated into the user interface 20 for that user 26. If the user's search query criteria is met by the desired fleet attributes 24 associated with one of the preprogrammed participating fleets 12, the host server 52 will preferably communicate its location (e.g., its IP address) and the file name and path containing the participant's SFDVs 22 back to the requesting user 26. If the benchmark query's criteria is not satisfied at the first level of preprogrammed host servers 52, the query criteria is forward by the first level host servers to each of their respective preprogrammed participant host servers, and so on. The benchmark query is thus propagated exponentially until the query criteria is either met by a participant host server 52 or until a predefined search level or time limit it is met. For a better understanding and a more detailed description of the Gnutella architecture 50 and its operation, features and functionalities, see http://computer.howstuffworks.com/file-sharing.htm/printable, the entire contents of which forms a part of this patent application is incorporated herein by reference.

For all of the various types of architectures 30, 40, 50 that may be used with the system 10, an embodiment of the user interface 20 capable of use with any of the architectures is an internet website that is preferably compatible with any internet web browser. Depending on the type of system architecture being utilized, users 26 may access to the user interface 20 by subscribing to the system (as in an ASP type architecture system 30) or the users 26 may download or otherwise purchase the software package comprising the user interface 20 for the Napster-type architecture 40 or Gnutella-type architecture 50 for running directly on the user's computer system.

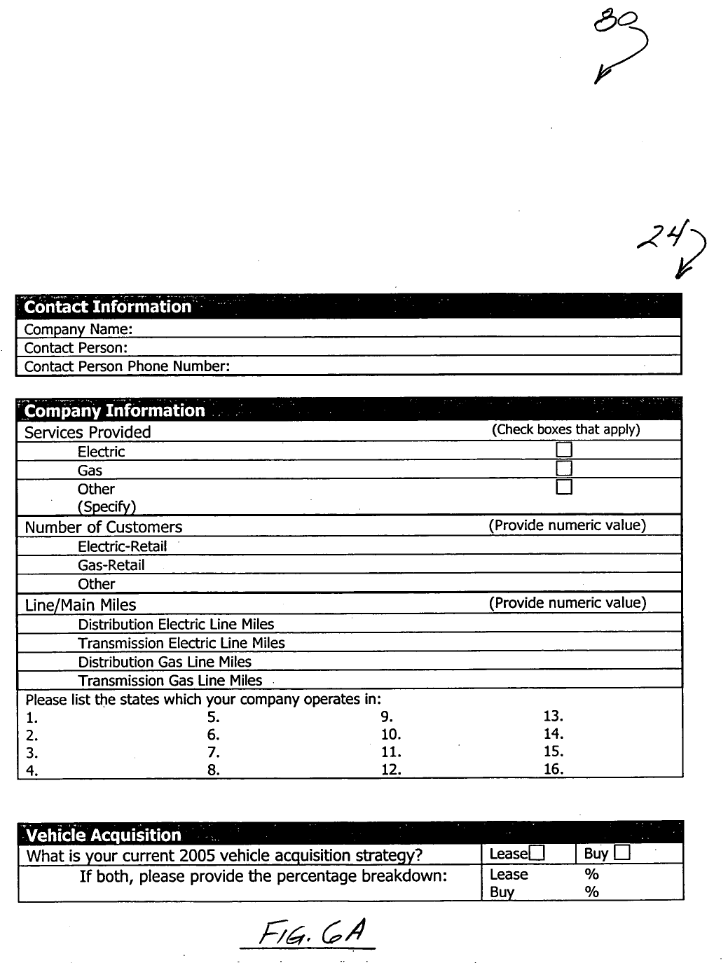

In the preferred ASP architecture system 30, users 26 may gain access to the system 10 by logging on through a secured website, such as by entering a username and password. To obtain a username and password, first time users 26 are preferably required to register through an online registration page 70 (FIG. 5). The registration page 70 preferably includes fields 72 for entering user attributes 74 to be associated with the user 26 seeking registration, such as, the user's name, address, telephone number, fax number, E-mail address, etc. These user attributes 74 are preferably associated with the user's username and password. If the user 26 is also a participant 12, the new user/participant may also be associated with certain rights to that participating fleet's SFDVs 22 not otherwise available to other participating fleets 12 and users 26. To create the association, the user/participant is preferably required to provide certain of its fleet attributes 24, such as the organization name, organization sector, and the organization address, by which the fleet participant 12 is associated with that user 26.

After a user/participant is registered, or as part of the registration process, the user/participant is preferably required to provide additional and more specific attributes 24 about the participant's fleet by which other users 26 of the system 10 can use for querying the system 10 to selectively retrieve desired the SFDVs 22 of the participating fleets 12 for generating reports. It should be appreciated that the more detailed the fleet attributes 24, the more selective the query can be, and the more detailed the reports can be.

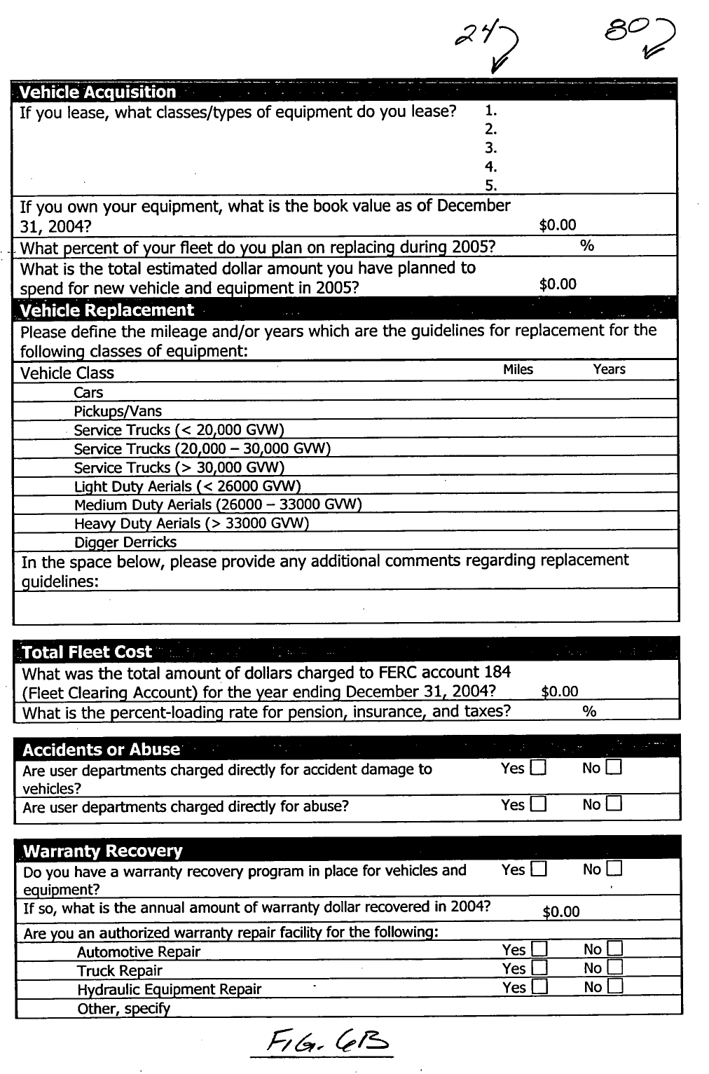

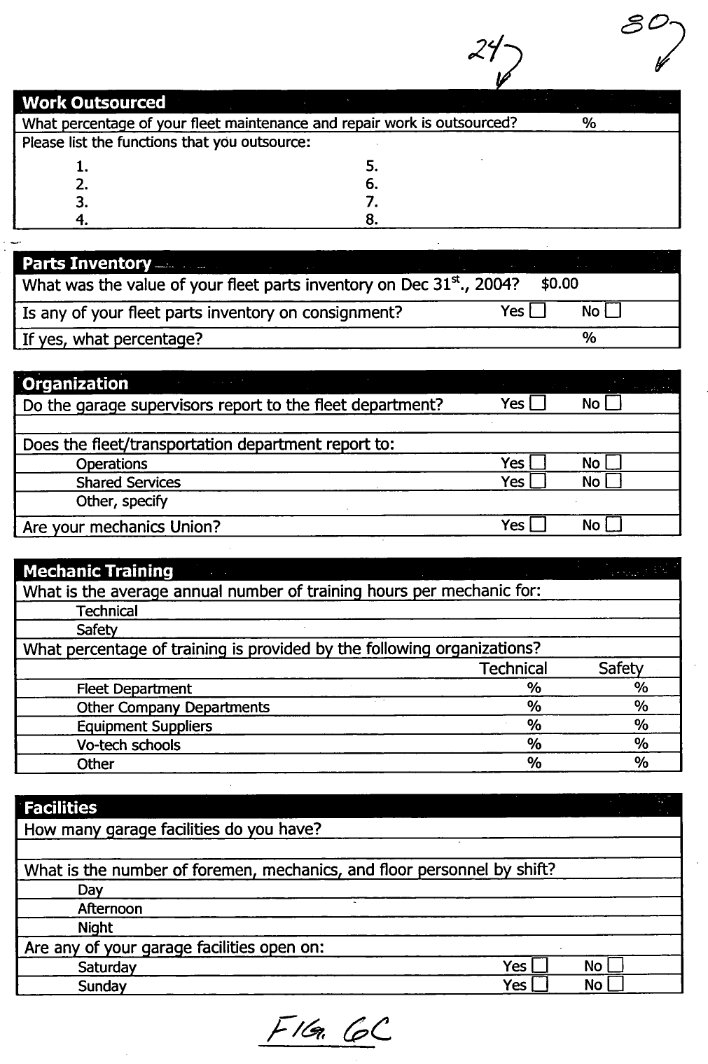

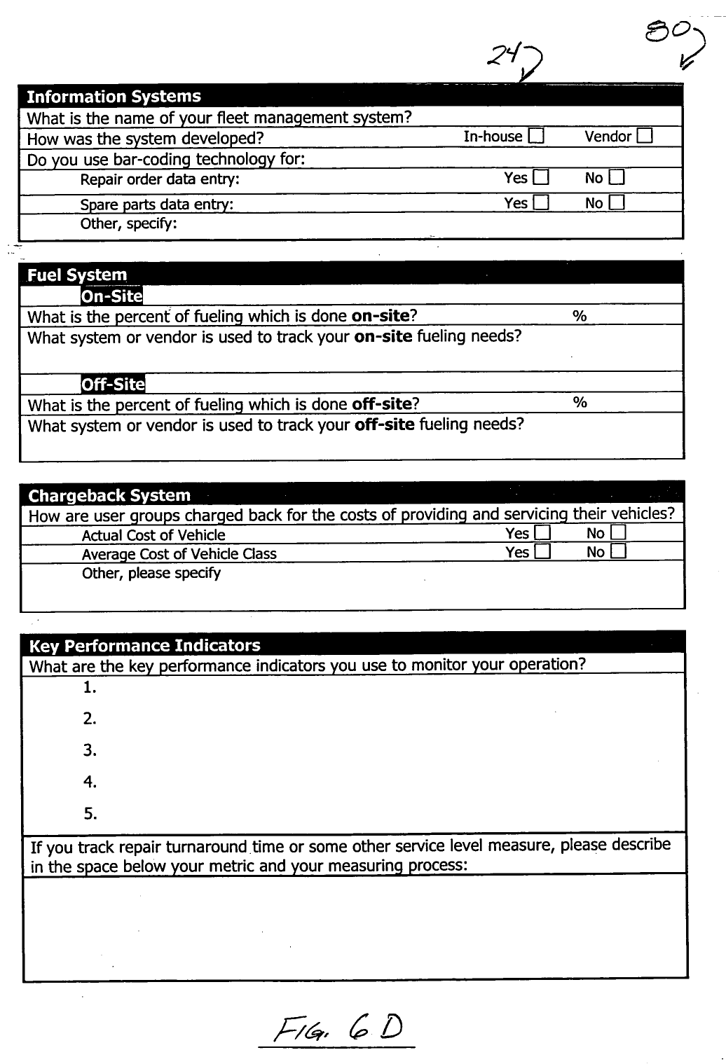

An embodiment of a fleet attribute form 80 for completion by a user/participant is illustrated in FIGS. 6A-6E. The fleet attribute form 80 of FIGS. 6A-6E is for a utility fleet (such as a gas or electric utility) and is provided as an example only. It should be appreciated that the specific fields of the fleet attribute form 80 may vary depending on the type of fleet and the level of detail by which users 26 may desire to obtain reports and benchmarks. Accordingly, the fleet attribute form 80 of FIGS. 6A-6E should not be construed as limiting the present invention to any specific fleet attributes or request form.

Under the ASP architecture system 30, the fleet attribute request form 80 preferably interfaces with the central database 32 such that the fleet attributes 24 entered into the form 80 automatically populates the applicable fields of the database 32 upon submission of the form 80 to the ASP system. In a less automated ASP architecture system 30, the fleet attributes 24 may be submitted in a non-electronic format to the ASP for manually inputting the fleet attributes 24 into the central database 32. In a more automated ASP architecture system 30, the participant's fleet attributes 24 may be a formatted data file for uploading to the central database 32. Those skilled in the art readily appreciate that there are multiple ways to upload the contents of data files into appropriate fields of a database and therefore further discussion of the specific steps for uploading data or data files into a central database is not warranted.

With the attributes 24 of the participating fleet 12 uploaded to or otherwise stored on the central database 32 and with attributes 24, 74 associated with the applicable user/participant, the fleet data values 16 may be uploaded to the central database 32 for “standardization” into SFDVs 22 to ensure a true apples-to-apples comparison between the data of different fleets who may be utilizing different fleet management programs and/or accounting practices. The preferred standardization method for generating SFDVs 22 is described below.

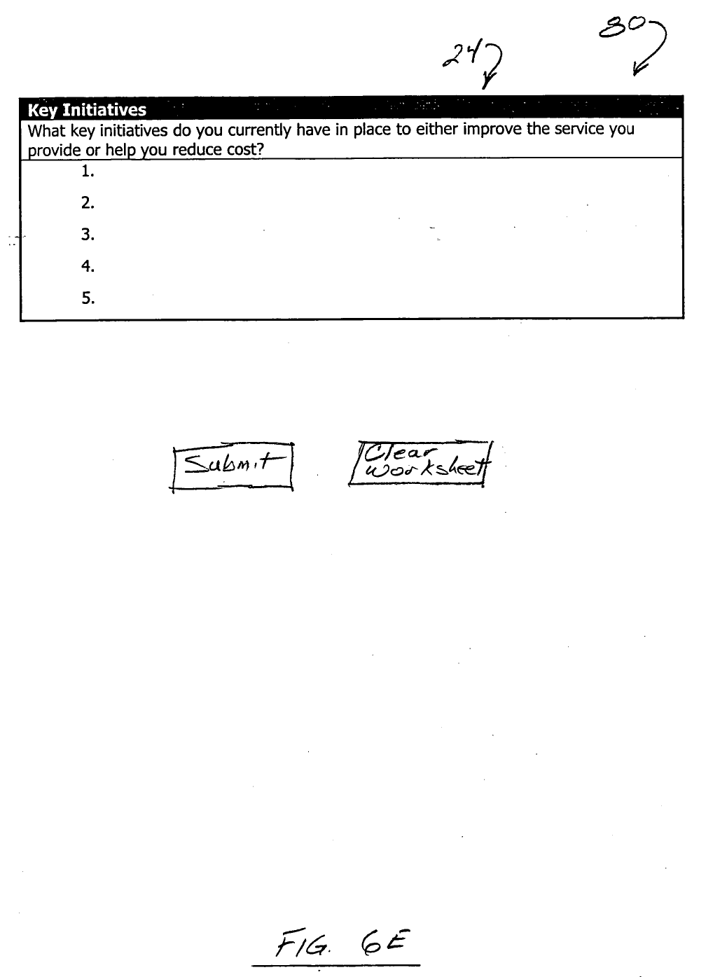

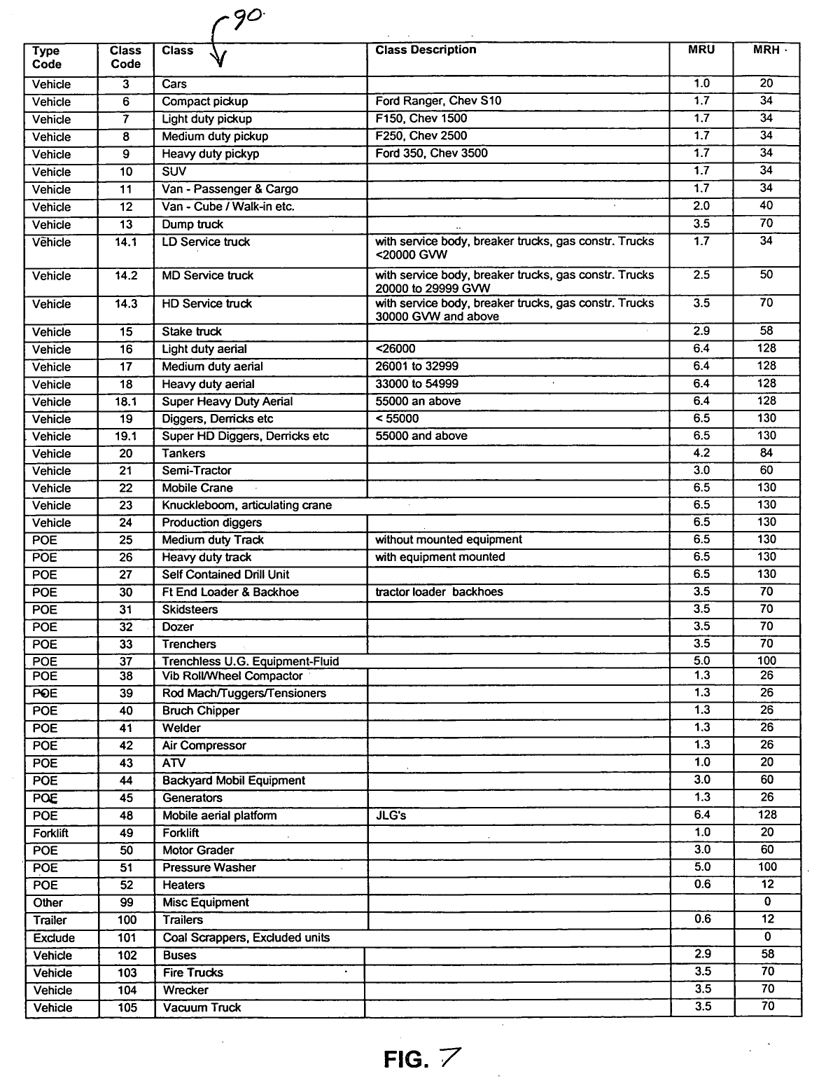

A uniform classification scheme must be defined for classifying the various units that may comprise a participant's fleet. An example of a classification scheme for various unit classes 90 is illustrated in FIG. 7 showing various types and classes of units that may comprise a fleet. Each of the various units comprising the participant's fleet must be classified according to this predefined classification scheme.

Although the SFDVs 22 may comprise any standardized data values, for purposes of this patent application, the SFDVs 22 comprise annual “fully loaded” unit costs. With fully loaded costs, a method of true apples-to-apples comparison on a per unit basis is achievable. The term “fully loaded” unit costs should be understood as including all ownership and operating costs of the unit together with an appropriate allocation of overhead costs to that unit.

Ownership costs may be broken out into lease costs, interest costs (if the unit is owned), depreciation costs, and license fees. Operating costs may include all mechanic labor costs, contract/vendor costs, parts and fuel costs.

Mechanic labor costs should include fully loaded mechanic labor costs. To arrive at a fully loaded labor cost, the fully loaded rate of each mechanic servicing the vehicle must be determined and multiplied by the mechanic's total hours recorded for servicing the unit. To determine each mechanic's fully loaded rate, the mechanic's straight hourly wage rate is determined. The straight hourly wage rate is the mechanic's hourly rate exclusive of any employee pension benefits, insurance benefits or taxes (PITs). The mechanic's fully loaded rate should also include any applicable overtime or incentive pay paid to the mechanic when servicing the unit. Additionally, the mechanic should be assigned a productivity allocator. The productivity allocator is determined by subtracting the employee's vacation time, sick time, paid time off (PTO) time, and training time from 2080 (the total labor hours available per year) and dividing the result by 2080. The mechanic's fully loaded rate is thus, the sum of the mechanic's straight hourly wage, overtime pay and incentive pay multiplied by the productivity allocator.

To arrive at an accurate fully loaded unit cost, a standard and uniform method of allocating overhead costs to each unit should also be determined. One method of arriving at a consistent and uniform method of allocating overhead costs on a per unit basis, is to develop an overhead allocator based on statistical data developed over time. A preferred overhead allocator is based on maintenance and repair hours (MRH) per unit class. Other overhead allocators may be equally suitable provided that such allocators are uniformly applied and is based on some reasonable measure.

FIG. 7 shows the average MRH determined for the various unit types and unit classes. For example, the average MRH per year for cars is 20 hours, for a heavy duty bucket truck, the MRH per year is 128 hours. By dividing the MRH value for a unit class by the fleet's total MRH for all units in the fleet, a ratio may be obtained for allocating a portion of the fleet's total overhead per unit within a class. For example, if the total MRH for all units of a participant's fleet equals 10,000 hours, the amount of overhead allocated to one car within that participant's fleet is ((20/10,000)×total overhead cost).

It should be understood that the percentage overhead attributable to a unit class may vary per industry. For example the MRH per car of an electric utility fleet may be different than the MRH per car for a courier service fleet. Additionally, the MRH per unit may vary over time. Furthermore, it should be understood that the more participants of a particular fleet type using the system 10 upon which the average MRH per unit class is based, the more precise the MRH measure will be.

In the preferred system 10, using the ASP architecture 30, the standardization of the fleet data values 16 is preferably performed automatically upon uploading the fleet data values 16 to the ASP system. As previously described, the fleet data values 16 are preferably output by the fleet's management program 14 into a predefined data file format. An example of a data file 18 is illustrated in FIG. 8 in which the data values 16 are organized into single column in a predefined order, with certain data values 16 being calculated fields. In the preferred embodiment, the data file 18 is uploaded by the user/participant 26 through the user interface 20 using an upload tool 92, an example of an embodiment of which is illustrated in FIG. 9, in which the user 26 specifies the file name and path for the data file 18 to be uploaded. Upon selecting the “upload” button, the appropriate commands are executed to copy the formatted data file 18 to the ASP's system to begin the standardization process, such as the process described above, to convert the fleet data values 16 into SFDVs 22. It should be understood that any other suitable method of copying or uploading data files to another computer system for processing may also be utilized and therefore, the system 10 should not be construed as being limited to the foregoing method.

With the SFDVs 22 of the fleet now populating the appropriate predefined fields of the central database 32, and the fleet attributes 24 associated with the fleet's SFDVs 22, users 26 may now execute queries to selectively retrieve the SFDV's 22 of a particular fleet 12 in various report formats. In the preferred embodiment, the user interface 20 includes a number of predefined report formats from which the user 26 may select for executing predefined queries that selectively retrieve and display the SFDVs 22 of a particular fleet 12 alone and/or in a comparative relation with the SFDVs 22 of other participating fleets 12 meeting a predefined query criteria. In addition the user interface 20 may permit a user 26 to define a custom query and report format.

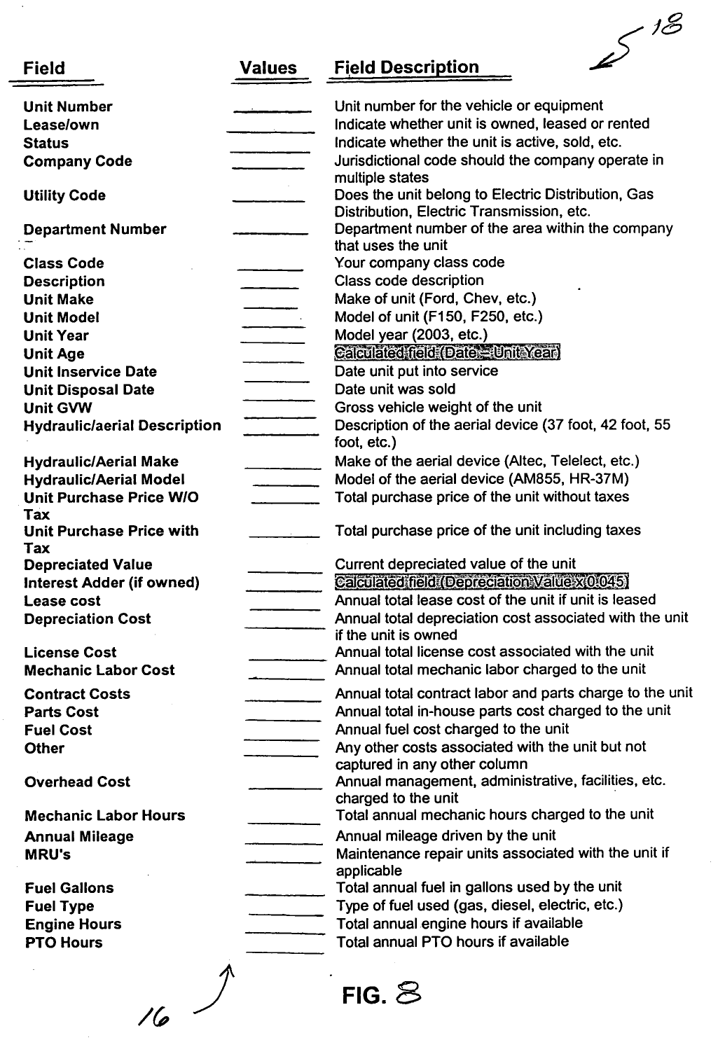

One predefined report format that may be available through the user interface 20 is a “Fleet Data Overview Report,” an example of which is shown in FIG. 10. Such a report preferably includes a summary of the current year's fleet costs categorized by ownership costs, by operating costs and by overhead. Additionally, the report also preferably displays the annual fleet costs in the same format for a predefined or selectable number of prior years.

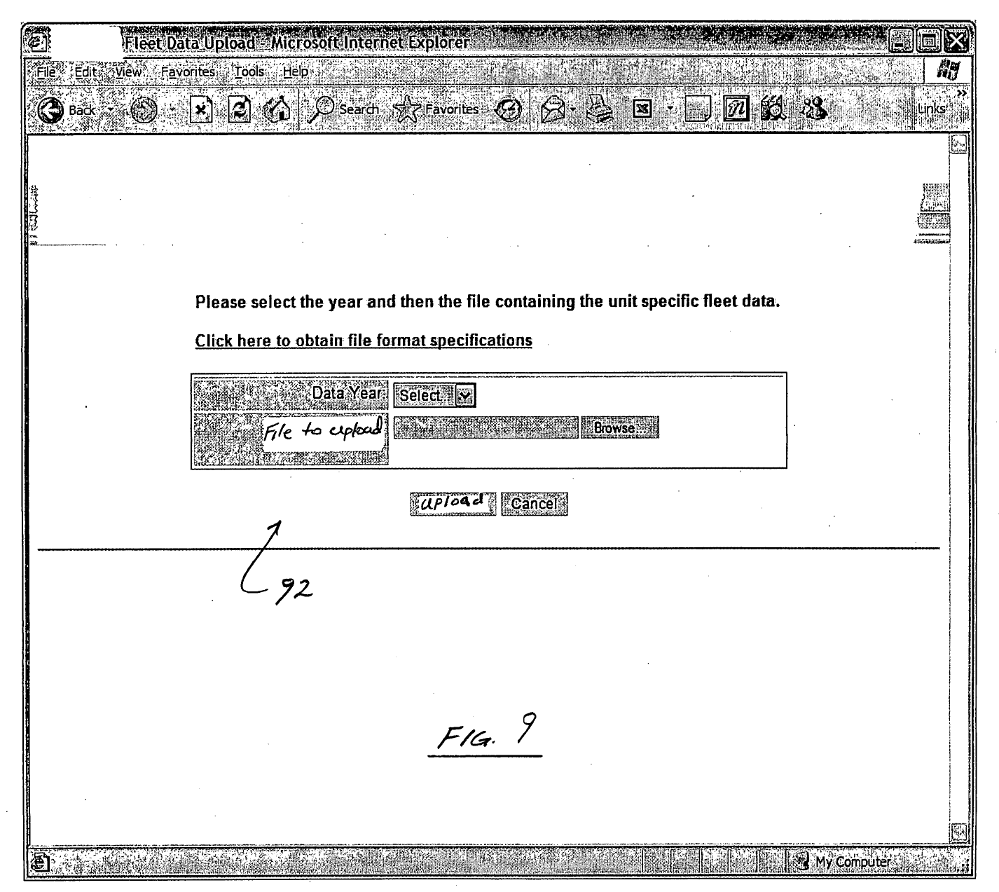

Another report that may be generated is a “Percentage Overview Report,” an example of which is shown in FIG. 11. This report preferably summarizes the annual fleet costs in the same categories as under the Fleet Data Overview Report, but in a percentage format.

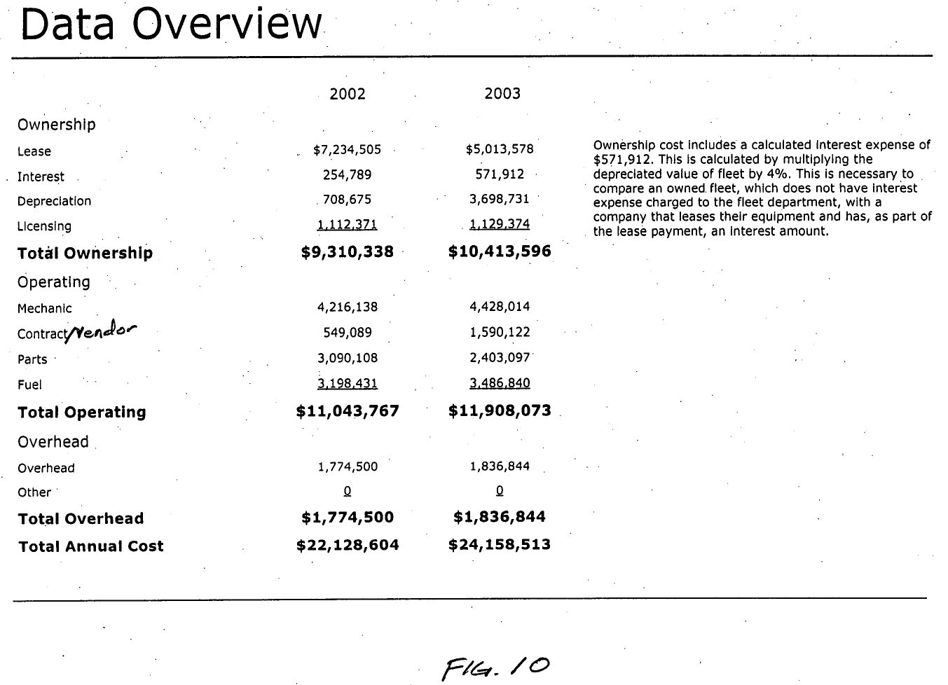

Another report that may be generated is a report illustrating “Classes as a Percentage of Total Fleet Makeup,” an example of which is shown in FIG. 12. The report of FIG. 12 displays the units comprising the fleet organized by class, and displays the number of units within each class, and the percentage of units in a class of the overall number of units in the fleet. Preferably, the fleet makeup percentage is benchmarked against other participating fleets 12 whose fleet attributes 24 satisfying benchmarking query criteria.

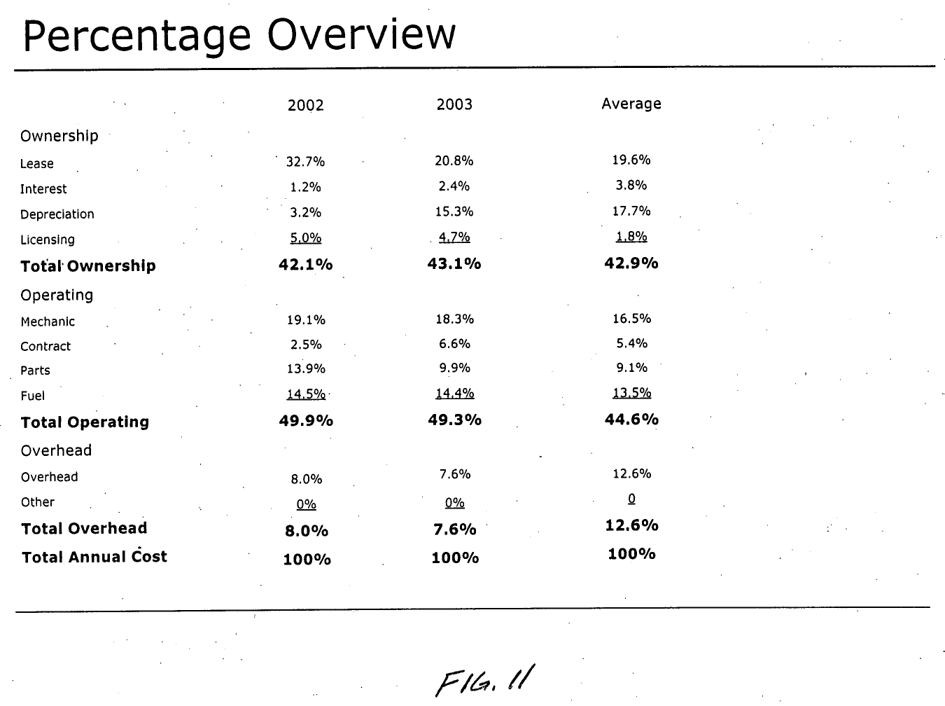

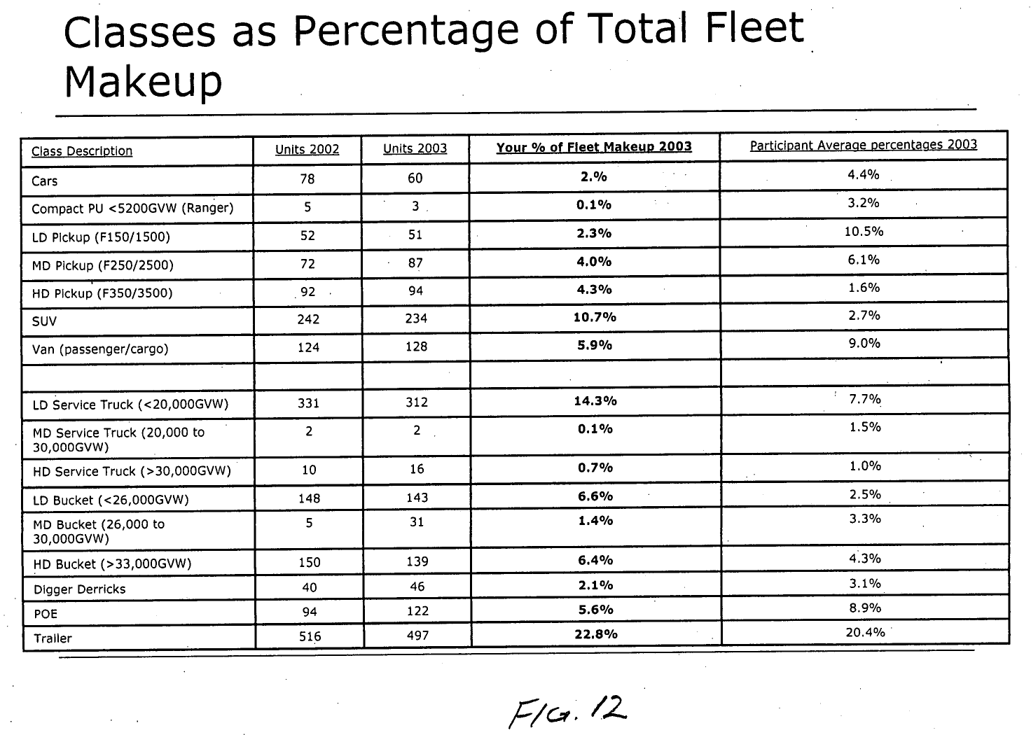

Another report that may be generated is a report of “Percentage of Total Cost,” an example of which is shown in FIG. 13. The report of FIG. 13 shows the fleet's current annual costs broken down by unit category (e.g., vehicles, POE, trailers, and other) in comparison to the fleet's annual costs by unit category for a predefined or selectable number of prior years. The report also preferably displays the fleet's annual costs in a percentage format by unit category in comparison against other participants whose fleet attributes 24 satisfy the benchmarking query criteria.

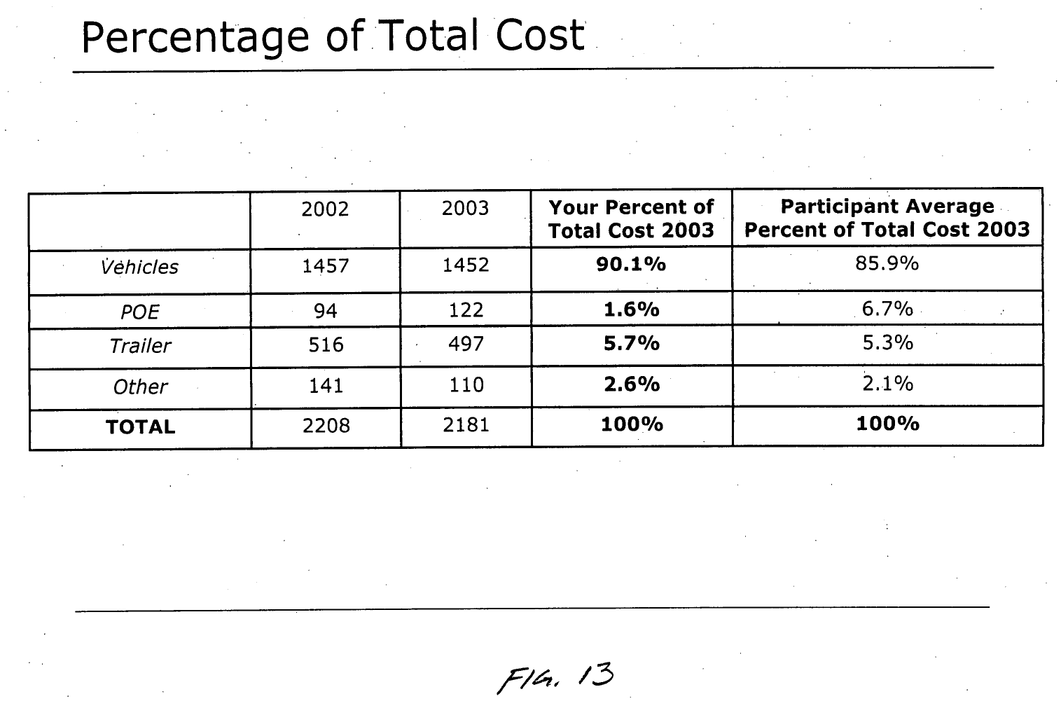

Another report that may be generated is a report illustrating “Class Cost as a Percentage of Total Cost,” an example of which is shown in FIG. 14. The report of FIG. 14 displays the number of units in each class comprising the fleet and each class's percentage of annual fleet costs in comparison to the participant average.

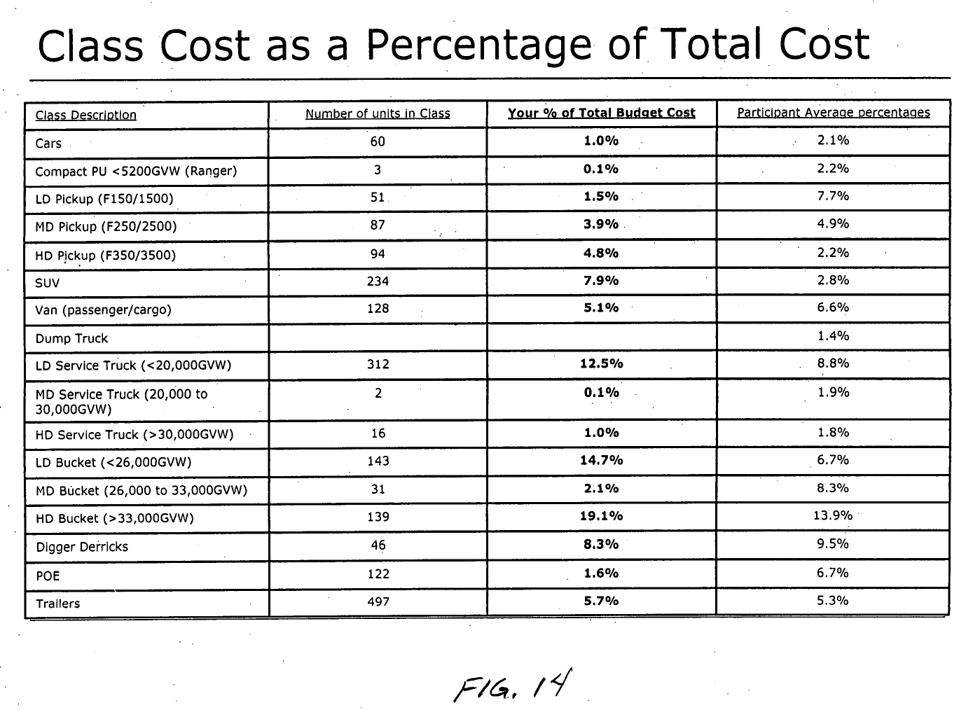

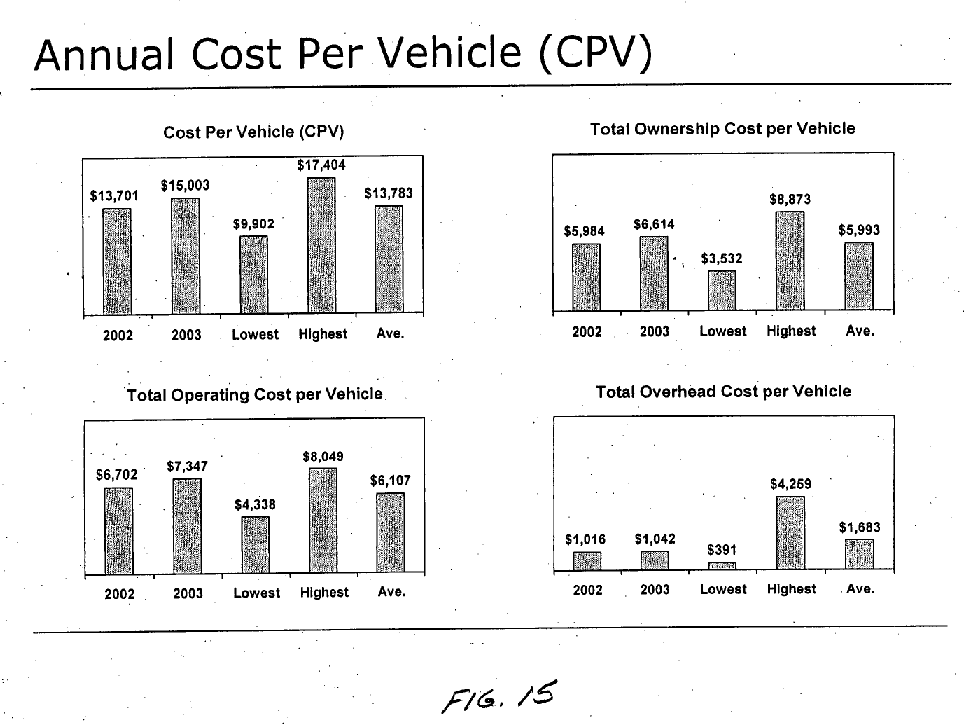

Other reports that may be generated include graphs of the annual costs of the various categories and/or classes of units comprising the fleet. Examples of such graphical reports and benchmarks are illustrated in FIGS. 15 and 16. In FIG. 15, the report displays the high, low and average annual costs per unit category (e.g., by vehicle, by trailer, and by POE) in relation to the average annual costs per unit category for a predefined or selectable number of previous years. Similarly, FIG. 15 displays the high, low and average total annual operating costs, ownership costs, and overhead cost per unit category in relation to previous years. FIG. 16 is substantially similar to the report of FIG. 15, but with the annual unit costs further broken down by unit class, which is a predefined subset of the unit category. For example, FIG. 16 displays the annual unit costs of the fleet's medium duty bucket trucks (defined, in this example as a bucket truck having a gross volume weight of between 26,000 lbs and 33,000 lbs), which is a class within the unit's type (i.e., bucket truck), which is, in turn, a subset of the unit's category (i.e., vehicle).

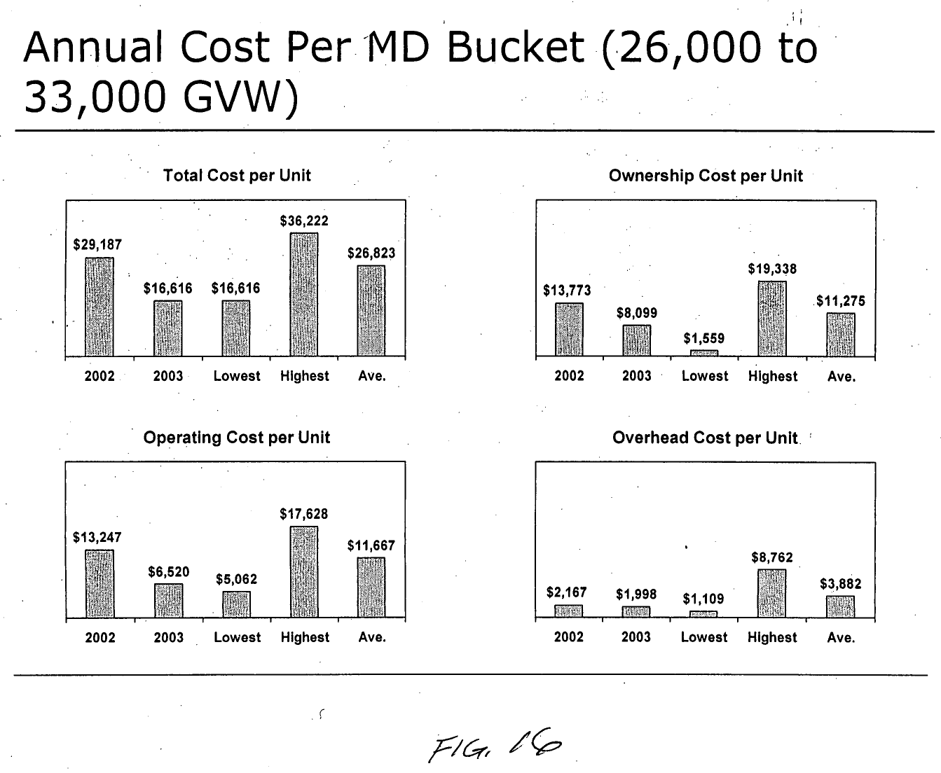

Another report that may be generated, for example as illustrated in FIG. 17, is the participant's annual cost per unit in a given year benchmarked against the annual cost per unit of other participants of the system 10 whose fleet attributes 24 satisfy the benchmarking query criteria. In the illustration of FIG. 17, the participant's annual cost per unit category (in this example, “vehicles”) is illustrated as being ranked nineteenth out of a total of twenty five participating fleets 12. Similar benchmarking reports could be generated at any other level, e.g., at the unit's type level (i.e., pickup, van, bucket truck, etc.), and at the unit's class level (i.e., medium duty bucket truck).

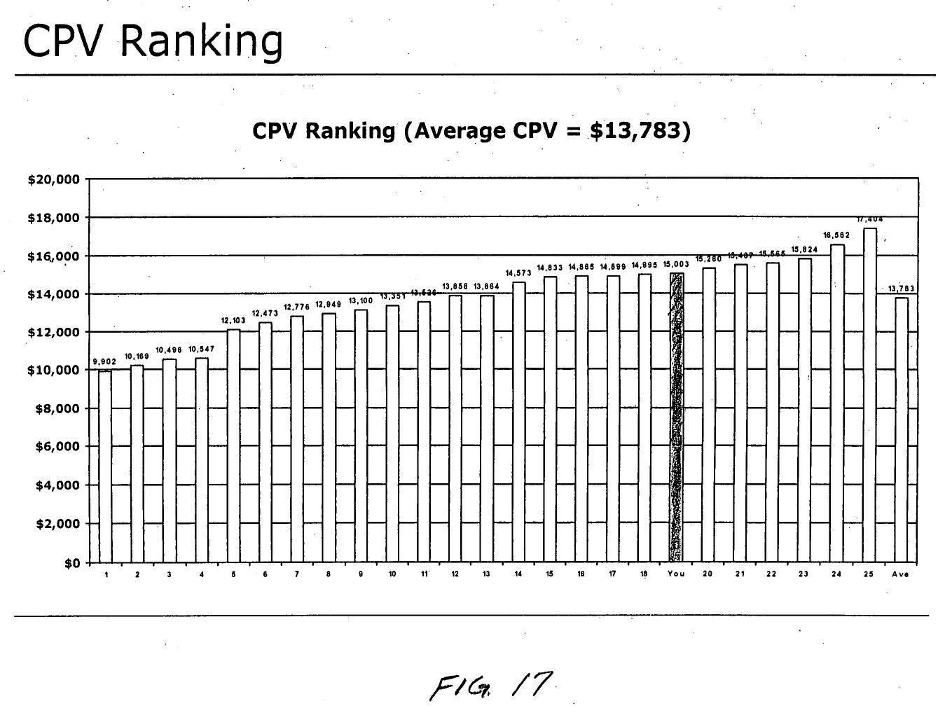

Another report that may be generated is the “Average Purchase Price Per Unit By Class” as illustrated in FIG. 18. Similar, to the example illustrated in FIG. 15, the report example of FIG. 18 displays the high, low and average purchase price per unit by class (e.g., by subcompact, light duty, medium duty and heavy duty pickup) in relation to the average annual costs per class for a predefined or selectable number of previous years. As with any of the other reports, the purchase price reports could be generated at any other level, e.g., at the unit's type level (i.e., pickup, van, bucket truck, etc.), and at the unit's category level (i.e., vehicle, trailer, POE).

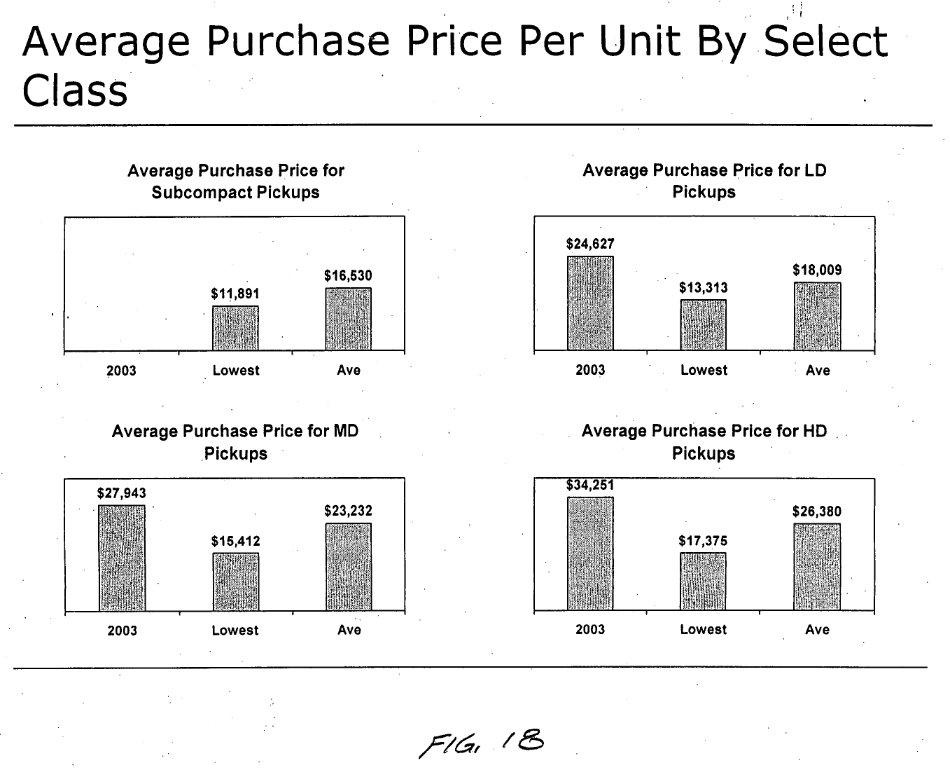

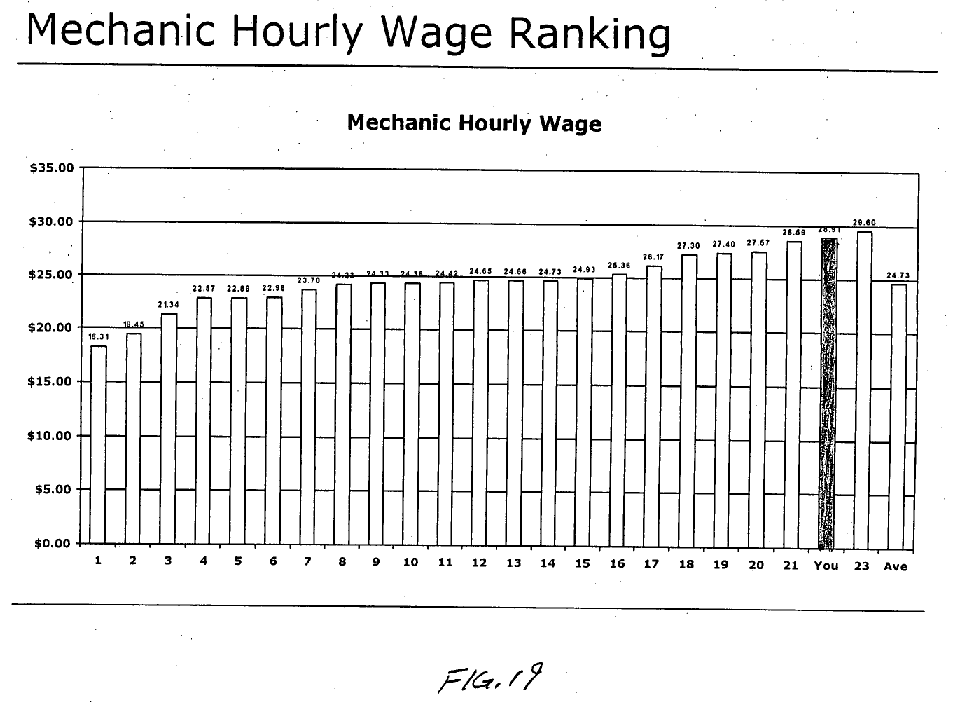

Another report that may be generated based on the participants' SFDVs 22 may include a report such as illustrated in FIG. 19 displaying the participant's average mechanic hourly wage benchmarked against the average mechanic hourly wages of other participants meeting the benchmarking query criteria. In this example, the participant's average mechanical hourly wage is ranked second from the highest out of the twenty three participants comprising the report that have met the user's benchmarking query criteria.

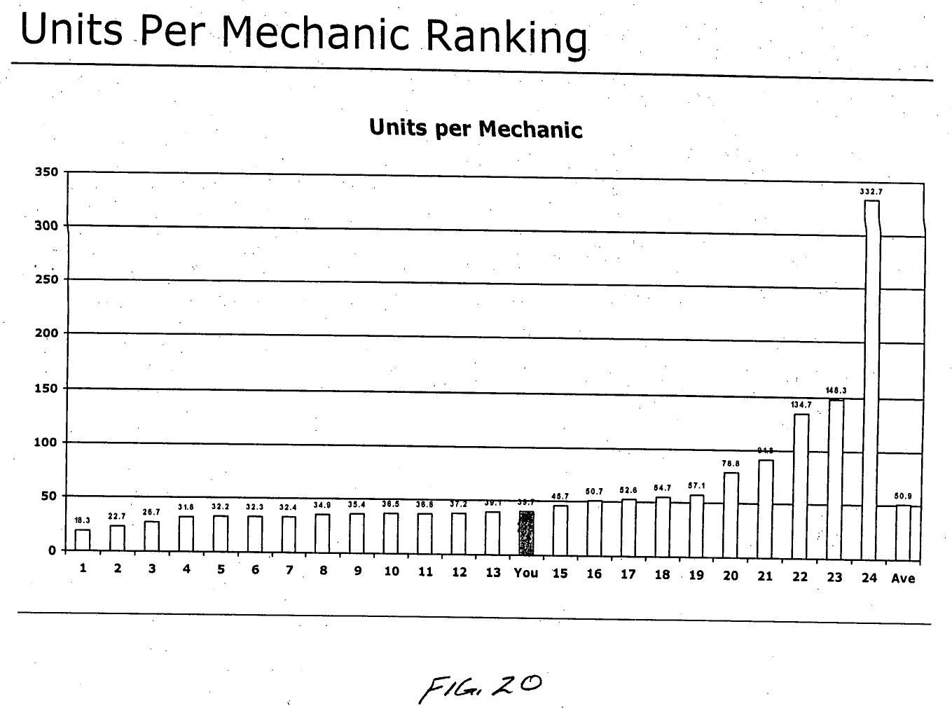

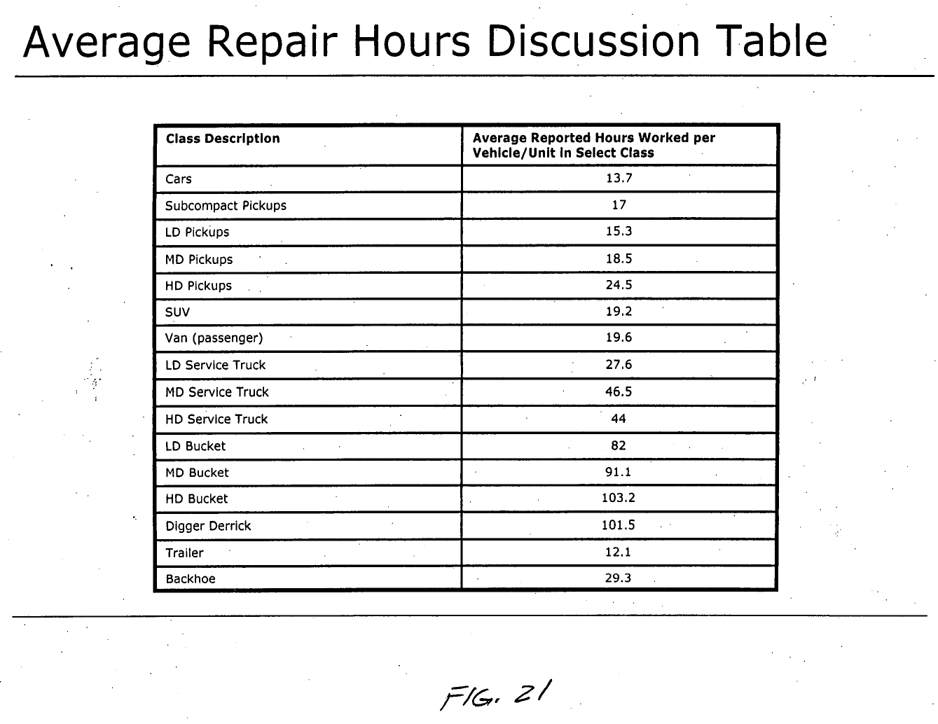

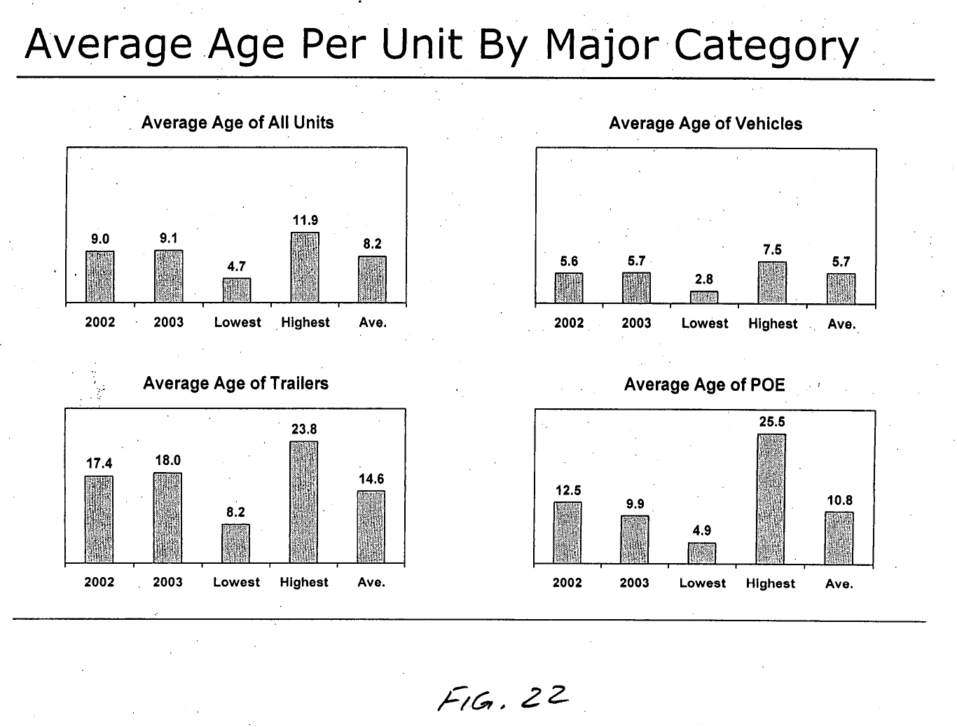

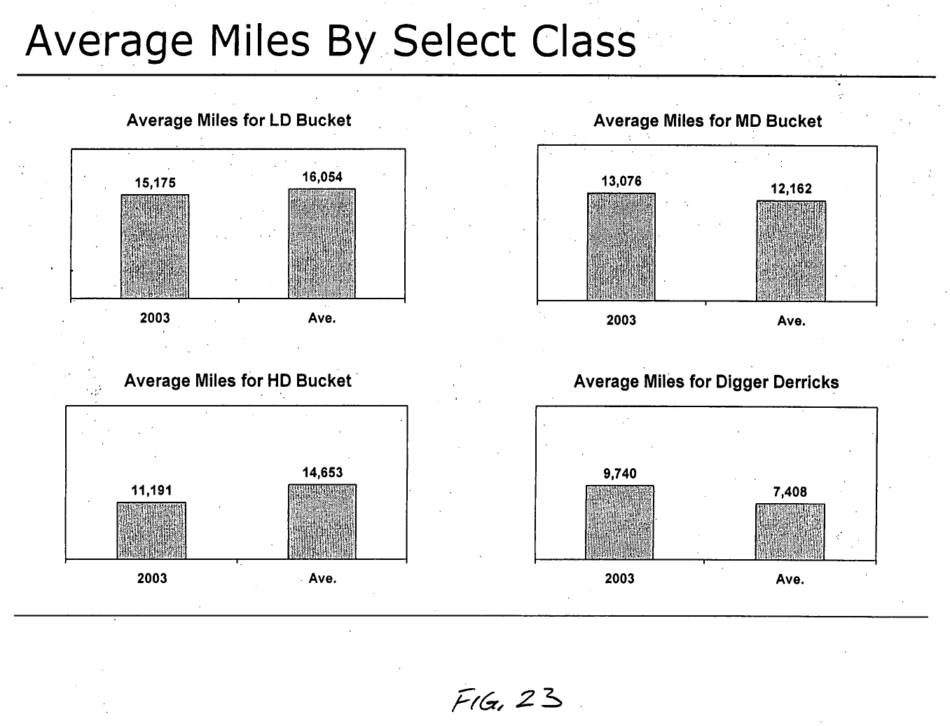

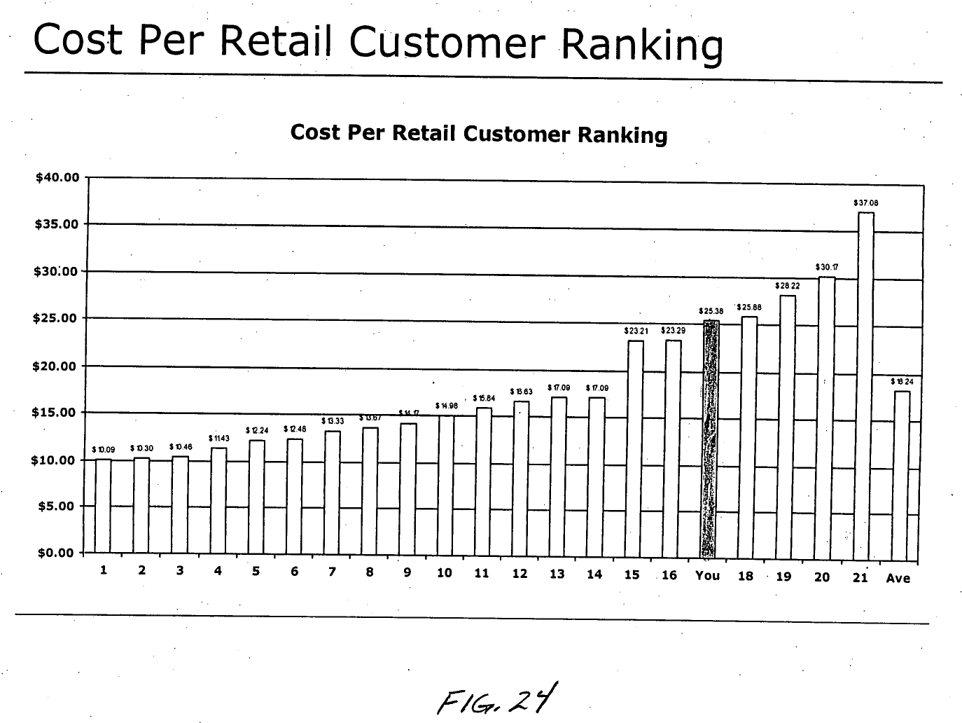

Another report that may be generated based on the participants' SFDVs 22 which may be useful to management of the fleet operation is a benchmark of the number of units serviced annually per mechanic, such as illustrated in FIG. 20. Still other reports may include “Average MRH Worked Per Unit Class” (for example as illustrated in FIG. 21), or “Average Age Per Unit” (for example as illustrated in FIG. 22), or “Average Miles by Unit” (for example as illustrated in FIG. 23), or “Cost Per Retail Customer” (for example as illustrated in FIG. 24). As with all the other types of reports previously identified, each of these types of reports may be at any level, whether based on the overall fleet, or by unit category, unit type, or unit class, and the report may take any format as desired by the user. Thus, it should be understood that each of the foregoing examples of the various types of reports that may be generated using the system 10 are provided for illustration purposes only and should not be construed as limiting the invention to any particular type of report style or format.

It should be appreciated that based on the foregoing types of reports and the other features and functionalities of the system 10, users 26 will have the capability to identify and understand where one particular fleet 12 is positioned relative to other participating fleets 12. Each participant will also have a better understanding of what strategies and business methods work and why. Armed with this information, each participant will have a guide as to which of their business practices require modification to match or achieve the values and strategies of those participants who are “best in class.”

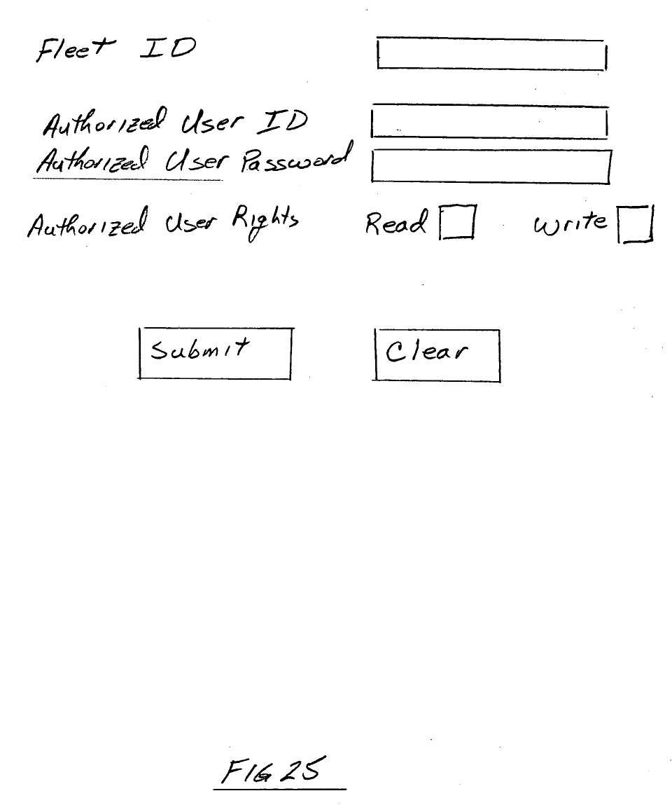

As previously discussed, there may be instances when a user/participant may wish to grant certain individuals or organizations, such as designated employees, investors, accountants, consultants, government agency etc., the right to view the participant's SFDVs 22 on a non-aggregated basis, and to generate one or more of the reports as previously described. To maintain this type of control, the user interface 20 preferably includes a page through which a user/participant may designate other authorized users to view and/or upload the participant's SFDVs 22 and to generate reports based thereon. As shown in FIG. 25 a user/participant may add authorized users by entering a user ID and password for each authorized user 26 and by designating the authorized user's access rights by selecting either or both the “read” or “write” rights. Selecting “read” grants the user the right to view or “read” the participant's SFDVs 22 on a non-aggregated basis. Selecting “write” grants the user 26 the ability to upload or write the data file 18 to the ASP system 30. By selecting both “read” and “write” the authorized user is granted both read and write authorization.

As previously identified, there are various vehicle fleet management software applications currently on the market. Many of these software applications are essentially nothing more than specialized accounting applications particularly directed toward tracking or monitoring income and expenses associated with a vehicle fleet. Other commercially available vehicle fleet management software applications incorporate or interface with telematics systems to provide real-time vehicle mapping and vehicle usage data. Still other vehicle fleet management software applications provide vehicle routing, scheduling, and dispatching functionalities for optimizing vehicle fleet operations. Many of these scheduling applications also incorporate or interface with accounting programs and telematics systems. Examples of some commercially available fleet management systems include FleetFocus™ by Maximus, Inc. and Faster® by CCG Systems, Inc.

The system 10 of the present invention is preferably capable of interfacing with or otherwise sharing data values with any fleet management system to further automate the method of uploading the data file 18 to the ASP system 30 for standardization. Depending on the type of fleet and the features and functionalities desired by the users 26, the fleet's SFDVs 22 may be uploaded or transferred to the central server 32 at any desired increment, whether on an annual basis, quarterly basis, monthly, weekly, daily or on a real-time basis. The method of accomplishing such interfacing or data sharing functionalities and the frequency for uploading or transferring the SFDVs 22, will likely vary between software applications. Those of ordinary skill in the art readily appreciate how to accomplish such interfacing or data sharing functionalities. Therefore, any further discussion of such functionalities or their methods of accomplishing such functionalities is unnecessary for the purpose of satisfying the written description and best mode requirements for this patent application.

Furthermore, it should be understood that although the foregoing description of the fleet system 10 focused primarily upon utilizing the ASP type architecture system 30, those of ordinary skill in the art would readily appreciate how to modify the system 10 from the ASP type architecture system 30 to apply it to the Napster and Gnutella type P2P file sharing type architectures 30, 40 and therefore, further discussion of the features, functionalities and methods of accomplishing such modifications is unnecessary for the purpose of satisfying the written description and best mode requirements for this patent application.

Although only exemplary embodiments of the invention has been described above, those skilled in the art will readily appreciate that many modifications are possible without materially departing from the novel teachings and advantages of this invention. Accordingly, all such modifications are intended to be included within the scope of this invention as defined in the following claims.

1. A fleet data reporting and benchmarking method, said method comprising:
(a) for a first participant, generating unit specific fleet data values using said first participant's fleet management program;
(b) through a user interface, standardizing said first participant's generated unit specific fleet data values based upon predetermined criteria;
(c) through said user interface, associating attributes of said first fleet with said first participant's standardized fleet data values;
(d) for other fleet participants, generating unit specific fleet data values of each of said other participants fleets using each of said other participants' respective fleet management programs;
(e) through said user interface, standardizing each of said other participants' generated unit specific fleet data values based upon said predetermined criteria;
(f) through said user interface, associating attributes of each of said other participants' fleets with each of said respective other participants' standardized fleet data values;
(g) through said user interface, executing a benchmarking query defined by certain of said attributes to selectively retrieve certain of said standardized data values of said first participant and said other participants having said certain attributes;
(h) generating a report displaying said certain selectively retrieved standardized data values of said first participant in relation to said standardized data values of said other participants having said certain attributes.

2. The method of claim 1, wherein said predetermined criteria includes a unit classification scheme.

3. The method of claim 2, wherein said predetermined criteria includes determining the fully loaded annual costs of each unit comprising the fleet.

4. The method of claim 3, wherein determining the fully loaded annual costs of each unit includes, determining the fully loaded ownership costs for each unit.

5. The method of claim 4, wherein determining the fully loaded annual costs of each unit, further includes determining the fully loaded operating costs for each unit.

6. The method of claim 5, wherein determining the fully loaded annual costs of each unit, further includes applying a proportional amount of the fleet overhead to each unit.

7. The method of claim 5 wherein determining the fully loaded operating costs for each unit includes determining the fully loaded mechanic labor costs, contract costs, parts costs and fuel costs per unit.

8. The method of claim 7 wherein determining the fully loaded mechanic labor costs for each unit includes identifying the straight hourly wage rate of each mechanic that has serviced the unit, multiplying each mechanic's hourly rate by the mechanic's time servicing the unit, adding to the product each mechanic's overtime pay and incentive pay, and multiplying the sum by the mechanic's productivity allocator.

9. The method of claim 8 wherein the mechanic's productivity allocator is determined by subtracting the mechanic's total vacation time, sick time and any other paid time off for the year from a predefined number of available working hours during the year and dividing the difference by said predefined number of available working hours.

10. The method of claim 9 wherein said predefined number of available hours is approximately 2080.

11. The method of claim 6 wherein the proportional amount of the fleet overhead applied to each unit comprising the fleet is the average required maintenance hours for the unit class divided by the fleet's total maintenance hours for all units comprising the fleet, the quotient multiplied by the fleet's total overhead.

12. The method of claim 1 wherein said attributes include fleet type attributes.

13. The method of claim 2 wherein said attributes include unit class attributes.

14. The method of claim 13 wherein said attributes include geographic attributes.

15. The method of claim 14 wherein said geographic attributes include state codes where the fleet operates.

16. The method of claim 1 utilizing an application service provider architecture.

17. The method of claim 1 utilizing a Napster-type architecture.

18. The method of claim 1 utilizing a Gnutella-type architecture.

19. A fleet data reporting and benchmarking method, comprising:
(a) for a first participant, generating unit specific fleet data values using said first participant's fleet management program;
(b) standardizing said generated unit specific fleet data values of said first participant's based upon predetermined criteria;
(c) uploading said standardized fleet data values of said first participant to a central database using a user interface;
(d) uploading attributes relating to said first participant's fleet to said central database using said user interface and associating said first participant's fleet attributes with said first participant's uploaded standardized fleet data values;
(e) for at least one other fleet, generating unit specific fleet data values of said at least one other fleet using said at least one other fleet's fleet management program;
(f) standardizing said generated unit specific fleet data values of said at least one other fleet based upon said predetermined criteria;
(g) uploading said standardized fleet data values of said at least one other fleet to said central database using said user interface;
(h) uploading attributes relating to said at least one other fleet to said central database using said user interface and associating said at least one other participant's fleet attributes with said at least one other participant's uploaded standardized fleet data values;
(i) through said user interface, executing a benchmarking query defined by certain of said attributes to selectively retrieve certain of said standardized data values of said first participant and said at least one other participant having said certain attributes;
(j) generating a report displaying said certain selectively retrieved standardized data values of said first participant in relation to said standardized data values of said at least one other participant having said certain attributes.

20. The method of claim 19, wherein said predetermined criteria includes a unit classification scheme.

21. The method of claim 20, wherein said predetermined criteria includes determining the fully loaded annual costs of each unit comprising the fleet.

22. The method of claim 21, wherein determining the fully loaded annual costs of each unit includes, determining the fully loaded ownership costs for each unit.

23. The method of claim 22, wherein determining the fully loaded annual costs of each unit, further includes determining the fully loaded operating costs for each unit.

24. The method of claim 23, wherein determining the fully loaded annual costs of each unit, further includes applying a proportional amount of the fleet overhead to each unit.

25. The method of claim 23 wherein determining the fully loaded operating costs for each unit includes determining the fully loaded mechanic labor costs, contract costs, parts costs and fuel costs per unit.

26. The method of claim 25 wherein determining the fully loaded mechanic labor costs for each unit includes identifying the straight hourly wage rate of each mechanic that has serviced the unit, multiplying each mechanic's hourly rate by the mechanic's time servicing the unit, adding to the product each mechanic's overtime pay and incentive pay, and multiplying the sum by the mechanic's productivity allocator.

27. The method of claim 26 wherein the mechanic's productivity allocator is determined by subtracting the mechanic's total vacation time, sick time and any other paid time off for the year from a predefined number of available working hours during the year and dividing the difference by said predefined number of available working hours.

28. The method of claim 27 wherein said predefined number of available hours is approximately 2080.

29. The method of claim 28 wherein the proportional amount of the fleet overhead applied to each unit comprising the fleet is the average required maintenance hours for the unit class divided by the fleet's total maintenance hours for all units comprising the fleet, the quotient multiplied by the fleet's total overhead.

30. The method of claim 19 wherein said attributes include fleet type attributes.

31. The method of claim 20 wherein said attributes include unit class attributes.

32. The method of claim 31 wherein said attributes include geographic attributes.

33. The method of claim 32 wherein said geographic attributes include state codes where the fleet operates.

34. A fleet data reporting and benchmarking method, comprising:
(a) for a first participant, generating unit specific fleet data values using said first participant's fleet management program;
(b) through a user interface standardizing said generated unit specific fleet data values of said first participant's based upon predetermined criteria;
(c) storing said standardized fleet data values in a designated file on said first participant's computer system;
(d) uploading attributes relating to said first participant's fleet to a central index server and associating said uploaded attributes with the file name and path of said designated file;
(e) for at least one other participant, generating unit specific fleet data values of said at least one other participant using said at least one other participant's fleet management program;
(f) through said user interface standardizing said generated unit specific fleet data values of said at least one other participant based upon said predetermined criteria;
(g) storing said standardized fleet data values of said at least one other participant on said at least one other participant's computer system;
(h) uploading attributes relating to said at least one other fleet to said central index server and associating said uploaded attributes of said at least one other participant's fleet with the file name and path of said designated file of said at least one other participant;
(i) through said user interface, executing a benchmarking query defined by certain of said attributes to locate the file name and path of the designated file of said at least one other participant having said certain attributes;
(j) accessing the located designated file to selectively retrieve certain standardized data values of said at least one other participant based on said certain attributes;
(k) generating a report displaying said certain selectively retrieved standardized data values of said located data file in relation to said standardized data values of said first participant.

35. The method of claim 34, wherein said predetermined criteria includes a unit classification scheme.

36. The method of claim 35, wherein said predetermined criteria includes determining the fully loaded annual costs of each unit comprising the fleet.

37. The method of claim 36, wherein determining the fully loaded annual costs of each unit includes, determining the fully loaded ownership costs for each unit.

38. The method of claim 37, wherein determining the fully loaded annual costs of each unit, further includes determining the fully loaded operating costs for each unit.

39. The method of claim 38, wherein determining the fully loaded annual costs of each unit, further includes applying a proportional amount of the fleet overhead to each unit.

40. The method of claim 39 wherein determining the fully loaded operating costs for each unit includes determining the fully loaded mechanic labor costs, contract costs, parts costs and fuel costs per unit.

41. The method of claim 40 wherein determining the fully loaded mechanic labor costs for each unit includes identifying the straight hourly wage rate of each mechanic that has serviced the unit, multiplying each mechanic's hourly rate by the mechanic's time servicing the unit, adding to the product each mechanic's overtime pay and incentive pay, and multiplying the sum by the mechanic's productivity allocator.

42. The method of claim 41 wherein the mechanic's productivity allocator is determined by subtracting the mechanic's total vacation time, sick time and any other paid time off for the year from a predefined number of available working hours during the year and dividing the difference by said predefined number of available working hours.

43. The method of claim 42 wherein said predefined number of available hours is approximately 2080.

44. The method of claim 43 wherein the proportional amount of the fleet overhead applied to each unit comprising the fleet is the average required maintenance hours for the unit class divided by the fleet's total maintenance hours for all units comprising the fleet, the quotient multiplied by the fleet's total overhead.

45. The method of claim 34 wherein said attributes include fleet type attributes.

46. The method of claim 35 wherein said attributes include unit class attributes.

47. The method of claim 46 wherein said attributes include geographic attributes.

48. The method of claim 47 wherein said geographic attributes include state codes where the fleet operates.

49. A fleet data reporting and benchmarking method, comprising:
(a) for a first participant, generating unit specific fleet data values using said first participant's fleet management program;
(b) through a first user interface standardizing said generated unit specific fleet data values of said first participant's based upon predetermined criteria, said user interface having a preprogrammed address for communicating with at least one other participant;
(c) storing said standardized fleet data values in a designated file on said first participant's computer system and associating said standardized fleet data values with attributes relating to said first participant's fleet with said designated file;
(d) for at least one other participant, generating unit specific fleet data values of said at least one other participant using said at least one other participant's fleet management program;
(e) through another user interface standardizing said generated unit specific fleet data values of said at least one other participant based upon said predetermined criteria, said another user interface having a preprogrammed address for communicating with at least another participant;
(f) storing said standardized fleet data values of said at least one other participant in a designated data file on said at least one other participant's computer system and associating attributes relating to said at least one other participant's fleet with said designate data file;
(g) through said first user interface, said first participant executing a query defined by certain attributes to search the attributes associated with the designated file of said at least one other preprogrammed participant;
(i) accessing the designated file of said at least one other preprogrammed participant if said at least one other preprogrammed participant has said certain attributes, otherwise said at least one other preprogrammed participant communicating and forwarding said query to said at least another preprogrammed participant;
(j) generating a report displaying certain selectively retrieved standardized data values retrieved by said query in relation to said standardized data values of said first participant.

50. The method of claim 49, wherein said predetermined criteria includes a unit classification scheme.

51. The method of claim 50, wherein said predetermined criteria includes determining the fully loaded annual costs of each unit comprising the fleet.

52. The method of claim 51, wherein determining the fully loaded annual costs of each unit includes, determining the fully loaded ownership costs for each unit.

53. The method of claim 52, wherein determining the fully loaded annual costs of each unit, further includes determining the fully loaded operating costs for each unit.

54. The method of claim 53, wherein determining the fully loaded annual costs of each unit, further includes applying a proportional amount of the fleet overhead to each unit.

55. The method of claim 54 wherein determining the fully loaded operating costs for each unit includes determining the fully loaded mechanic labor costs, contract costs, parts costs and fuel costs per unit.

56. The method of claim 55 wherein determining the fully loaded mechanic labor costs for each unit includes identifying the straight hourly wage rate of each mechanic that has serviced the unit, multiplying each mechanic's hourly rate by the mechanic's time servicing the unit, adding to the product each mechanic's overtime pay and incentive pay, and multiplying the sum by the mechanic's productivity allocator.

57. The method of claim 56 wherein the mechanic's productivity allocator is determined by subtracting the mechanic's total vacation time, sick time and any other paid time off for the year from a predefined number of available working hours during the year and dividing the difference by said predefined number of available working hours.

58. The method of claim 57 wherein said predefined number of available hours is approximately 2080.

59. The method of claim 58 wherein the proportional amount of the fleet overhead applied to each unit comprising the fleet is the average required maintenance hours for the unit class divided by the fleet's total maintenance hours for all units comprising the fleet, the quotient multiplied by the fleet's total overhead.

60. The method of claim 49 wherein said attributes include fleet type attributes.

61. The method of claim 50 wherein said attributes include unit class attributes.

62. The method of claim 61 wherein said attributes include geographic attributes.

63. The method of claim 62 wherein said geographic attributes include state codes where the fleet operates.
